(19) United States
(12) Patent Application Publication
(10) Pub. No.: US 2026/0254126 A1
(43) Pub. Date: Aug. 27, 2026

(54) Configuration of an Intelligent Reflective Surface

(71) Applicant: Telefonaktiebolaget LM Ericsson (publ), Stockholm (SE)

(72) Inventors: Maksym Girnyk, Solna (SE); Emil Björnson, Hägersten (SE); Parisa Ramezani, Spånga (SE)

(21) Appl. No.: 19/163,495

(22) PCT Filed: Mar. 13, 2023
(86) PCT No.: PCT/SE2023/050225

§ 371 Date: Sep. 9, 2025

(51) Int. Cl. H01Q 15/14; H01Q 1/24; H01Q 3/44

(52) U.S. Cl. CPC H01Q 15/148; H01Q 1/246; H01Q 3/44

(57) ABSTRACT

Disclosed is a method performed by a network node (130) of a wireless communication network (100), for configuring an intelligent reflective surface, IRS (150) of the wireless communication network (100), the IRS (150) comprising a plurality of dual-polarized reflective elements. The method comprises determining a configuration for the IRS, the configuration comprising individual phase shifts per first and second polarization of the plurality of dual-polarized reflective elements, determined so that the IRS can redirect a signal, received from the network node as a dual-polarized beam, over an angular sector made up from a plurality of angular subsectors, as a beam having substantially same power-domain array factor over the angular subsectors Hereby, the IRS (150) is able to reflect a signal received from the network node (130) as a broad beam towards one or more wireless devices (140, 142) residing in the angular sector.

### TECHNICAL FIELD

The present disclosure relates generally to methods and network nodes for configuring an intelligent reflective surface of the wireless communication network. The present disclosure further relates to computer programs and carriers corresponding to the above methods and nodes.

### BACKGROUND

In wireless communication networks, the number of wireless communication devices, aka wireless devices, is increasing day by day as well as demand for higher throughput. Consequently, there is an ongoing search for physical-layer technologies that can play a role in increasing the throughput over the air interface between wireless devices and network nodes, i.e. base stations.

One such technology that is up for discussion is to use Intelligent Reflective Surfaces (IRS), also known as Reconfigurable Intelligent Surfaces (RIS). An IRS is a means to control the propagation environment of a wireless communication link, i.e., air interface, between a transmitter and a receiver, for example between a network node and a wireless device. An IRS is a low-cost and low-complexity passive signal reflector comprising a multitude of reflecting elements that can be configured to have different impedance aka reflection coefficients or beamforming weights, e.g., phase shift and possibly also amplitude shift incurred by an individual element. The impedance pattern of the IRS determines how incident waves are reflected/scattered. An IRS is usually planar and used to redirect the signal propagation path to, e.g., overcome mid-term link blockages. That is, whenever the direct link between the transmitter and receiver is blocked, e.g., by a building, the signal can take an indirect route in two stages: transmitter-IRS and IRS-receiver. This is discussed in “Reconfigurable Intelligent Surfaces: Three myths and two critical questions”, by Björnson et al., published in IEEE Communications magazine 58. 12, year 2020, pages 90-96 [Ref. 1]. When the IRS has a line-of-sight path to both the transmitter and receiver, while the direct transmitter-receiver link is blocked, the IRS can create a virtual line-of-sight path via itself. A typical IRS has hundreds of elements, and the configuration of those elements can be represented by a vector of equal length as number of elements, or matrix of equal length and width as number and position of elements in case of a rectangular 2D array, the vector or matrix containing the reflection coefficients.

To improve reception at the receiver, an IRS typically adjusts the impedance pattern, e.g., phase and amplitude shifts incurred by the individual elements, to reflect the signal from the transmitter as a beam towards the receiver. The configuration, however, requires precise channel state information at the IRS regarding the cascaded channel from the transmitter to the receiver via the IRS. There exist a multitude of channel estimation algorithms for the situation where the wireless device is already connected to the network node and scheduled for transmission. Some are described in “Channel estimation with reconfigurable intelligent surfaces-A general framework”, by Swindlehurst et al., published in Proceedings of the IEEE, Volume 110, Issue 9, September 2022, pages 1312-1338 [Ref. 2]. The resulting transmission becomes receiver specific. Therefore, such channel estimation algorithm cannot be used for broadcasting downlink control information to all wireless devices that are to be reached via the IRS at once. Also, such channel estimation algorithm cannot support uplink transmissions, such as random-access transmissions.

The coverage range of wireless communication networks is defined by the locations where those operations can be carried out. If the IRS has a fixed configuration during initial access, the coverage would be the same as if it is replaced by a metal plate. If the IRS is reconfigured during initial access, as stated above, accurate channel state information is needed which is typically unavailable. Therefore, the best-known solution today to deliver broadcast information to wireless devices via an IRS is an IRS configuration sweep, like analog beam-sweeping, which requires very long sweeps proportional to the number of elements and thereby results in an initial access operation with high latency. Consequently, there is a need of a better way to reach wireless devices with broadcast information via an IRS. Also, there is a need of a better way for supporting uplink random access transmissions.

### SUMMARY

It is an object of the invention to address at least some of the problems and issues outlined above. It is an object of embodiments of the invention to make it possible that a signal originating from a network node is retransmitted by an IRS over a broad coverage area, or broad coverage/reflecting angle. It is another object of embodiments to provide a beamforming scheme for an IRS that creates a broad radiation pattern from the IRS for a signal that the IRS has received from the network node. It is possible to achieve these objects and others by using methods, and network nodes as defined in the attached independent claims.

According to one aspect, a method is provided, which is performed by a network node of a wireless communication network, for configuring an IRS of the wireless communication network. The IRS comprises a plurality of dual-polarized reflective elements. Each dual-polarized reflective element is independently controllable regarding phase shift for a first polarization and phase shift for a second polarization orthogonal to the first polarization. The method comprises determining a configuration for the IRS, wherein the configuration comprises individual phase shifts per first and second polarization of the plurality of dual-polarized reflective elements. The individual phase shifts are determined so that the IRS can redirect a signal, received from the network node as a dual-polarized beam, over an angular sector made up from a plurality of angular subsectors as a beam having substantially same power-domain array factor over the angular subsectors. Further, in the determining, the individual phase shifts per first and second polarization of the dual-polarized reflective elements are compensated for a phase shift of the signal received from the network node. The method further comprises triggering application of the determined configuration at the IRS, and transmitting, after the triggering of application of the determined configuration, a signal towards one or more wireless devices residing in the angular sector via reflection at the IRS.

According to another aspect, a network node is provided, which is configured to operate in a wireless communication network, and operative for configuring an IRS of the wireless communication network. The IRS comprises a plurality of dual-polarized reflective elements. Each dual-polarized reflective element is independently controllable regarding phase shift for a first polarization and phase shift for a second polarization orthogonal to the first polarization. The network node comprises a processing circuitry and a memory. Said memory contains instructions executable by said processing circuitry, whereby the network node is operative for determining a configuration for the IRS, the configuration comprising individual phase shifts per first and second polarization of the plurality of dual-polarized reflective elements. The individual phase shifts per first and second polarization of the plurality of dual-polarized elements are determined so that the IRS can redirect a signal, received from the network node as a dual-polarized beam, over an angular sector made up from a plurality of angular subsectors as a beam having substantially same power-domain array factor over the angular subsectors. Further, in this determining, the individual phase shifts per first and second polarization of the dual-polarized reflective elements are compensated for a phase shift of the signal received from the network node. The network node is further operative for triggering application of the determined configuration at the IRS, and for transmitting, after the triggering of application of the determined configuration, a signal towards one or more wireless devices residing in the angular sector via reflection at the IRS.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic diagram of a wireless communication network in which the present invention may be used.

FIG. 2 is a flow chart illustrating a method performed by a network node, according to possible embodiments.

FIG. 3 is a schematic block diagram of an example of an IRS that may be used in embodiments of the invention.

FIG. 4 is a schematic diagram of a wireless communication network where an IRS is used for reflecting signals directed to a certain wireless device.

FIG. 5 is a schematic diagram of a wireless communication network where an IRS is used for reflecting signals as a broad beam towards one or more wireless devices, e.g., for broadcasting signals, according to embodiments of the invention.

FIG. 6 is a Cartesian coordinate system showing phase shift on the x-axis and amplitude on the y-axis and corresponding circuit-specific parameters plotted.

FIG. 7 is a Cartesian coordinate system showing angle on the x-axis and array factor on the y-axis for different algorithms.

FIG. 8 is a block diagram illustrating a network node in more detail, according to further possible embodiments.

### DETAILED DESCRIPTION

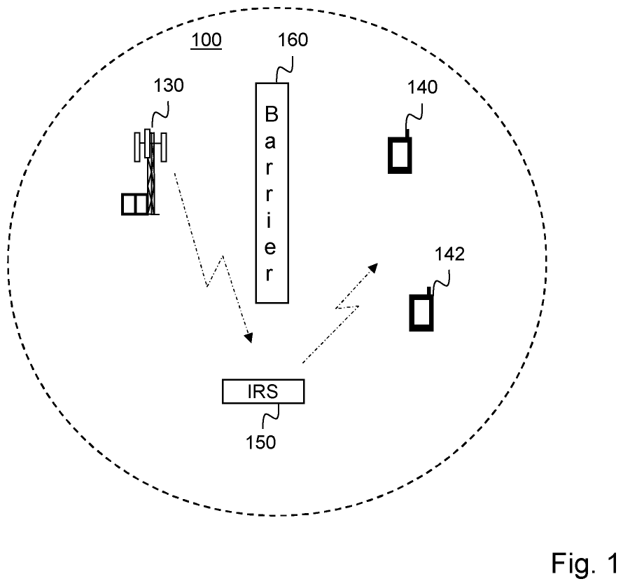

FIG. 1 shows a wireless communication network 100 comprising a radio access network (RAN) node aka a network node 130 that is in, or is adapted for, wireless communication with wireless communication devices aka wireless devices 140, 142 via reflection at an IRS 150. The network node 130 provides radio access in a cell covering a geographical area. In FIG. 1 is also shown a barrier 160, which may be for example a house, wall etc., which hinders line of sight communication between the network node 130 and the wireless devices 140, 142. In order to reach the wireless devices and to be able to control the directions of signals sent after reflection at the IRS 150, the IRS is controlled or configured by the network node.

The wireless communication network 100 may be any kind of wireless communication network that can provide radio access to wireless devices. Example of such wireless communication networks are networks based on Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The network node 130 may be any kind of network node that can provide wireless access to wireless devices 140, 142 alone or in combination with another network node. Examples of network nodes 130 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH) and a multi-standard BS (MSR BS).

The wireless devices 140, 142 may be any type of devices capable of wirelessly communicating with a network node 130 using radio signals. For example, the wireless devices 140, 142 may be a User Equipment (UE), a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE), an Internet of Things (IoT) device, etc.

The invention is based on the fact that it is more efficient to distribute broadcast information to a plurality of wireless devices via a broad beam that can reach many wireless devices at the same time, instead of sending many signals via narrow beams, each signal comprising the broadcast information. Consequently, there is an object to configure an IRS so that it can redistribute or reflect a signal that it receives from a network node as a broad beam that can reach many wireless devices at once.

This is achieved by using an IRS that comprises a plurality of dual-polarized reflective elements, wherein each dual-polarized reflective element is independently controllable regarding phase shift for a first polarization and phase shift for a second polarization orthogonal to the first polarization. The IRS is then configured with individual phase shifts per first and second polarization of the plurality of dual-polarized elements, which individual phase shifts are determined so that the IRS can redirect a signal, received from the network node as a dual-polarized beam, over an angular sector made up from a plurality of angular subsectors as a beam having substantially same power-domain array factor over the angular subsectors. That the power-domain array factor is substantially the same over the angular subsectors could mean that the variance is less than or equal to 1 dB over the angular sector. Also, in the configuration, the IRS is configured to compensate for a phase shift of the signal received from the network node when received at the IRS, so that the redirected signal is spread as a beam over the angular sector, which beam has substantially the same power-domain array factor over each of the angular subsectors that together make up the broader angular sector.

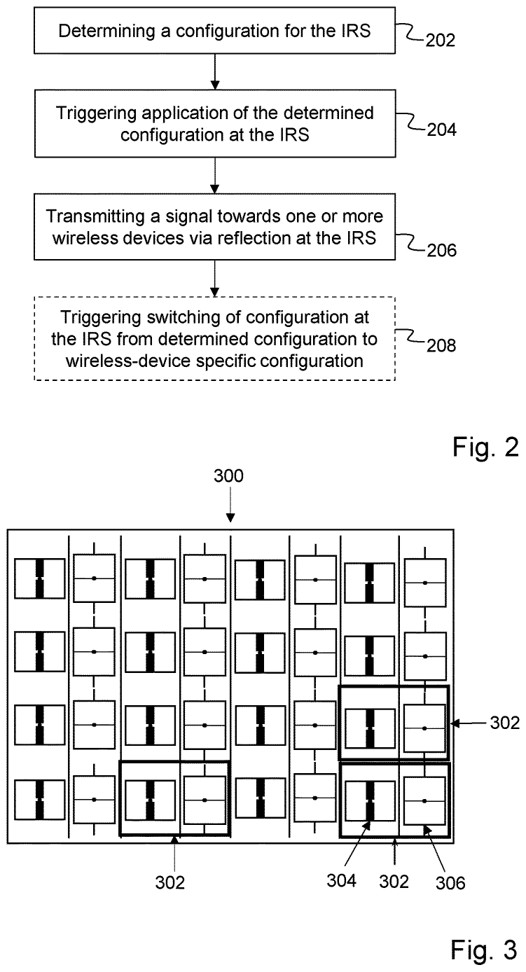

FIG. 2, in conjunction with FIG. 1, describes a method performed by a network node 130 of a wireless communication network 100, for configuring an IRS 150 of the wireless communication network 100. The IRS 150 comprises a plurality of dual-polarized reflective elements. Each dual-polarized reflective element is independently controllable regarding phase shift for a first polarization and phase shift for a second polarization orthogonal to the first polarization. The method comprises determining 202 a configuration for the IRS, wherein the configuration comprises individual phase shifts per first and second polarization of the plurality of dual-polarized reflective elements. The individual phase shifts are determined so that the IRS can redirect a signal, received from the network node as a dual-polarized beam, over an angular sector made up from a plurality of angular subsectors as a beam having substantially same power-domain array factor over the angular subsectors. Further, in the determining, the individual phase shifts per first and second polarization of the dual-polarized reflective elements are compensated for a phase shift of the signal received from the network node. The method further comprises triggering 204 application of the determined configuration at the IRS 150, and transmitting 206, after the triggering of application of the determined configuration, a signal towards one or more wireless devices 140, 142 residing in the angular sector via reflection at the IRS 150.

By such a method, an IRS is configured so that it redirects a signal received from the network node as a broad beam that covers a broad angular sector in which a plurality of wireless devices that are intended to receive the signal after reflection at the IRS are positioned. A further advantage is that the part of the signal transmission from the IRS to wireless devices becomes less sensitive to the location of the wireless devices, and hence the availability of channel state information. A further advantage is that it also allows to serve several wireless devices at once whenever broadcasting is needed. Further, the method does not require a configuration sweep but can use one single IRS configuration.

That each dual-polarized reflective element is independently controllable regarding phase shift for a first polarization and phase shift for a second polarization orthogonal to the first polarization can be implemented in many possible ways. In one embodiment, a dual-polarized element has a first single-polarized reflective element and a second single-polarized reflective element mutually orthogonal to the first single-polarized element. In another embodiment, a dual-polarized element may be implemented as a cross element, often called an X-pol, which has two ports, one for each polarization. Yet another alternative implementation is that the IRS is arranged as two sub-parts arranged on top of each other, one with first single-polarized reflective elements and the other with second single-polarized reflective elements, the two sub-parts being arranged so that a first and a second single-polarized elements can be said to make up a dual-polarized reflective element even if they are arranged on two different sub-parts.

That the beam has substantially same power-domain array factor over the angular subsectors may signify that over the angular subsectors, that is over the whole angular sector comprising the angular subsectors, the beam has substantially the same power-domain array factor. “Substantially the same power-domain array factor” can be interpreted as the variation of the power-domain array factor for the beam over the angular sector being less than 1 dB. The angular sector should be set so that it covers the one or more wireless devices so that the wireless devices that are to receive e.g. broadcast information will receive it with substantially the same signal strength, if they were positioned at the same distance from the network node. The angle and direction of the angular sector could thereby be different depending on where the wireless devices that are to receive the broadcast information are situated. The angular sector, however, could be set to be broader than an angular coverage of a reflected beam that is determined for one single wireless device. For example, the angular sector could be set to 30 degrees, 60 degrees or 90 degrees. Alternatively, the angular sector could be an angular sector covering the whole cell that the network node is to cover. For example, in case the network node is to cover a 120 degree sector cell, the angular sector is 120 degrees. Then it is ensured that all wireless devices residing in the cell are reached by the broadcast information. “Triggering application 204 of the determined configuration” may signify that the network node 130 transmits the configuration to the IRS 150 wirelessly or via wireline for application at the IRS 150, or, in case the IRS 150 is a part of the network node 130, that the network node 130 performs the application of the configuration at the IRS 150. There can be a controller in the IRS 150 that allows the network node 130 to control it.

The phase shift of the signal received by the IRS from the network node may be called the incident phase shift. There is normally a phase shift of a signal sent from the network node, when the signal is received at the IRS. This has to be taken care of by the IRS so that the individual phase shifts determined and thereafter configured to the IRS are the correct ones to achieve the wished broad beam. According to an embodiment, the incident phase shift is first taken care of on the received signal, before determining the individual phase shift per first and second single-polarized reflective elements. The incident phase shift is normally determined before it is time to send a signal via the IRS. This is possible as the network node and the IRS are stationary, i.e. they are positioned in the same mutual positions all the time. Also, the antennas of the network node as well as the reflective elements of the IRS are normally positioned in the same mutual positions. Thus, there is not much variation in the channel between the network node and the IRS over time. However, there may be reflections occurring for signals sent from the network node to the IRS due to e.g. passing vehicles, strong wind etc., but as there should be line-of-sight between the network node and the IRS, such over-time-varying reflections do not have much influence on the communication channel between the network node and the IRS. But, still, it can be possible or needed to calibrate the incident phase shift every now and then. This incident phase shift at the IRS can be theoretically determined from knowledge of the position and angle of the IRS in relation to the position and angle of the antenna array of the network node. Alternatively, the incident phase shift at the IRS can be determined by using a UE positioned at or close to the network node, which UE would receive signals sent by the network node to the IRS and reflected by the IRS and sent back again. Such determining of incident phase shift using transmission of signals can be done when setting up the IRS, before it is used for relaying traffic, or at re-calibrations. A possible implementation is to sweep the IRS's narrow-beam configurations until the UE at the network node position is found, e.g., by detecting a spike in the received power at the UE. Then it can be determined which beam at the IRS that corresponds to the network node position, hence which phase shift, determined by the angle of departure (which here would be the opposite to the incident angle) that will be needed to send the beam in the network node direction. Hence, it is possible to determine the incident angle and thereby the incident phase shift.

According to an embodiment, the individual phase shifts per first and second polarization of the plurality of dual-polarized elements are determined by subtracting the phase of the incident signal from the phase shifts determined so that the IRS can redirect a signal, received from the network node as a dual-polarized beam, over an angular sector made up from a plurality of angular subsectors as a beam having substantially same power-domain array factor over the angular subsectors.

According to an embodiment, in the determining 202 of a configuration for the IRS 150, the individual phase shifts per first and second polarization of the plurality of dual-polarized reflective elements are selected per first and second polarization so that over the angular sector, power in the first polarization and power in the second polarization of the redirected dual-polarized beam are complementing each other at each of the plurality of angular subsectors, resulting in that substantially the same power-domain array factor of the redirected dual-polarized beam is achieved over the plurality of angular subsectors. By selecting the individual phase shifts per dual-polarized reflective element, so that after reflection in the IRS the first and second polarizations of a dual-polarized beam complement each other over a plurality of angular subsectors of a broad angular sector, the incident dual-polarized beam is redirected by the IRS so that the reflected beam covers the requested broad angular sector with substantially the same power-domain array factor.

According to another embodiment, the individual phase shifts per first and second polarization of the plurality of dual-polarized reflective elements are selected as a pair of Golay arrays for which a sum of the aperiodic autocorrelation functions of the two Golay arrays of the pair is zero for each non-zero lag. Further, each Golay array in the pair has the same number of entries as there are dual-polarized reflective elements in the IRS. Further, one Golay array of the pair is applicable for the first polarization of the dual-polarized elements and the other Golay array of the pair is applicable for the second polarization of the dual-polarized elements. The pair of Golay arrays may be selected by picking an array pair from a list of existing Golay pairs, or the pair of Golay arrays can be determined from two smaller Golay arrays to obtain a larger Golay array pair, as is defined further below in this disclosure. When the aperiodic autocorrelation functions of two arrays is zero for each non-zero lag, zero side lobes of the sum aperiodic autocorrelation of the pair of Golay arrays is achieved. In other words, it is possible to create a flat power-domain array factor over the angular sector. For one dual-polarized element, one entry on a first position of the first Golay array is used for the first polarization and the corresponding entry of the other Golay array at the same first position of the second Golay array is used for the second polarization of the same dual-polarized element. In other words, if one Golay array is called x and the other Golay array of the same Golay array pair is called y, Golay array x and Golay array y both have N entries corresponding to N dual-polarized elements of the IRS. Dual polarized element n should then use entry n from array x and the same entry n from array y.

According to another embodiment, the individual phase shifts per first and second polarization of the plurality of dual-polarized reflective elements are selected as a pair of ε-complementary arrays for which a sum of the aperiodic autocorrelation functions of the two arrays of the pair is lower than ε for each non-zero lag, where ε≠0, each ε-complementary array in the pair having the same number of entries as there are dual-polarized reflective elements in the IRS, one ε-complementary array of the pair applicable for the first polarization of the dual-polarized elements and the other ε-complementary array of the pair applicable for the second polarization of the dual-polarized elements.

The use of ε-complementary arrays is a relaxation of the requirement of Golay arrays as in the previous embodiment, i.e. that the sum of the aperiodic autocorrelation functions (AACF) of the two arrays of the pair is zero except for in the zero lag. Instead, the array pair is allowed to have a sum AACF with certain imperfection by having small sidelobes of AACF bonded by ε. Bu such a relaxed requirement, it is possible to compute almost-complementary arrays for those configurations where Golay arrays are not known, or maybe do not even exist (this is yet to be proven). So, in other words, ε-complementary array pairs with ε=0 are Golay array pairs. ε is a maximum allowed level of sidelobes of AACF. ε can be set to for example 1% of the main lobe of the AACF. In other words, for non-zero lags, AACF will be ≤1% of maximum AACF at zero lag. Consequently, a limit is set on allowed fluctuation or ripple of the sum power spectral density for the array pair, which leads to spatially flat power-domain beam pattern with limited spatial fluctuation.

According to an alternative of this embodiment, the individual phase shifts per first and second polarization of the plurality of dual-polarized elements are determined by subtracting the phase of the incident signal from the phase shifts determined or selected as ε-complementary pairs. This may be accomplished as follows: Assuming that \hat{φ}_{m,n} is the phase shift of the element (m,n) of the IRS determined as the ε-complementary array and ϑ_{m,n} is the phase of the incident signal received by the element (m,n), the actual IRS phase shifts should be computed as φ_{m,n}=\hat{φ}_{m,n}−ϑ_{m,n}. In other words, the phase shift of the incident signal is here first cancelled and then the phase shift obtained from the ε-complementary algorithm is applied in order to get a broad beam.

According to yet another embodiment, the individual phase shifts per first and second polarization of the plurality of dual-polarized elements are determined taking into consideration, except for phase, also amplitude variations, by modelling the amplitude as a function of the phase. The amplitude variations are phase-dependent amplitude variations in the element-wise reflection coefficients. In other words, it is amplitude variations of the reflected signal that may occur due to the ISR configuration so that the ISR adds amplitude variations between the dual-polarized elements to the reflected signal, and that those amplitude variations are modelled as a function of phase so that the individual phase-shifts are selected to cancel out those added amplitude variations.

In other words, a certain connection between amplitudes and phases of the signals radiated by the elements of the IRS has been found. This embodiment takes benefit of this connection. The connection between amplitudes and phases can be modelled by a model referred to further down in this disclosure, or by any other model. When knowing the model, it can be incorporated into the algorithm that finds the ε-complementary array pair or the pair of Golay arrays. Hence the algorithm will be looking not for an ideal ε-complementary pair, i.e., that works in the absence of phase-amplitude dependency, but for a pair that will remain ε-complementary, i.e., with a sum AACF below ε for non-zero lags, even in the presence of the dependency between the amplitude and the phase. Thus, plugging in an ideal-complementary pair into an IRS array may lead to some distortion of the beam shape, while then instead plugging in the pair found by such an amplitude-aware algorithm may lead to an actually broad beam.

According to yet another embodiment, the method further comprises, after the transmitting 206 of a signal towards one or more wireless devices 140, 142, 144 residing in the angular sector, triggering switching 208 of configuration at the IRS from the determined 202 configuration to a wireless-device specific configuration. Alternatively, the triggering of application 204 of the determined configuration at the IRS comprises triggering switching of configuration at the IRS from a wireless-device specific configuration to the determined 202 configuration. By a “wireless-device specific configuration” is meant a configuration adapted to generate a narrow beam directed to a certain wireless device after reflection at the IRS. Such a switching can be triggered based on a fixed protocol, by control signals sent by the network node, or through random access signals, for example.

Even though the above embodiments have been described for a downlink transmission, they are as well applicable for an uplink transmission. Then the IRS is configured for receiving signals from one or more wireless devices being in a broad angular sector in a similar way as the IRS was configured to transmit or reflect signals in the broad angular sector at downlink transmission. Further, the IRS is configured to reflect the signals incoming from the one or more wireless devices in the broad angular sector and to transmit or reflect the incoming signals towards the network node.

In the following, different embodiments will be described for configuring an IRS for reflecting a received signal as a broad beam. But first a discussion of intelligent reflective surfaces (IRS) will follow.

An IRS, also known as a reconfigurable intelligent surface (RIS) and a software-controlled meta-surface, was created as a means to control the propagation environment, achieving better robustness against link blockage, minimizing cross-interference between links, amplifying signal for edge users, optimizing links for wireless power transfer, (see [Ref. 1]). This is a new concept that has emerged in discussions around future 6G wireless communication networks. An IRS is characterized by low hardware complexity and programmability. That is, an IRS is typically controlled by a network node, also known as base station (BS), via for example a network gateway or a microcontroller. IRSs are installed to improve communication links in terms of coverage and data rate by redirection of incident signals through passive beamforming. They are thought to be more scalable than massive Multiple Input Multiple Output (MIMO) and small cell deployments, for example, in the sense that a much larger number can be deployed for the same price. The deployment scenarios for IRSs are usually building walls, billboards, windows, as well as smart indoor environments, such as venues with walls, doors, floors and ceilings covered with IRSs, for enhancing outdoor-to-indoor coverage.

An IRS comprises elements, often referred to as reflective elements or alternatively meta-atoms, and typically manufactured using metamaterials. The size of a reflective element is smaller than the wavelength, similarly to elements in low-gain antennas. A reflective element of an IRS can be regarded as an antenna that captures a radio signal, creates a delay, and then re-radiates the signal. This is done as follows: An electromagnetic wave reaches an IRS, creating currents in the reflective elements via induction. The current pattern within the surface depends on the reflective element geometry and composition, as well as the states of switching elements, which determine the local impedance and thereby the complex reflection coefficient of the reflective element, i.e., the amplitude and phase shift at different frequencies. The switching element is a part of circuitry that actually changes the configuration, i.e., phase and amplitude, of a reflective element. The inducted current creates a response field which is radiated by the reflective element. The reflective elements are designed and configured in such a way that a desired current pattern is created, which yields a required response field.

A recent development in this field is enabling dual-polarized operation of IRSs where incoming waves with orthogonal polarizations can be controlled (almost) independently. This is described for example in “Dual-polarized RIS-assisted mobile communications”, by Han et al., published in IEEE transactions on wireless communications 21, pages 591-606, year 2021 [Ref. 3]. A dual-polarized IRS can be regarded as two co-located single-polarized IRSs, which in [Ref. 3] is implemented by dividing each dual-polarized reflective element into two pieces that reflect signals of opposite polarizations. Each polarization can be controlled independently through a corresponding interface. FIG. 3 shows an example of such a dual-polarized IRS 300. This dual-polarized IRS 300 comprises a plurality of dual-polarized reflective elements 302, each dual polarized reflective element having a first single-polarized reflective element 304 and a second single-polarized reflective element 306 mutually orthogonal to the first single-polarized element. The dual-polarized IRS 300 is hence capable of operating with two polarizations, which leads to potential gains that will be explored further down. A dual-polarized IRS retains the benefits of a conventional IRS of low hardware complexity, low cost and low power consumption.

One of the benefits of an antenna array of e.g., a network node is the ability to focus the radiated energy in an angular sector, thereby improving the received power of a receiver, e.g., a wireless device, located in said sector. This is achieved by forming a narrow beam from the antenna array of the network node by exciting the antennas with a beamforming weight vector, where the individual antennas are given different beamforming weights in order to create the beam to be directed in a selected direction. The maximum narrowness of the beam is determined by the aperture size of the array; a larger array typically has a narrower beam. This is beneficial for data transmission, as it increases the achievable data rate of a communication link. However, there are situations where it is needed to cover a certain wide angular range with similar radiation levels, e.g., control and broadcast channels for downlink communication from a network node to a wireless device, such as Physical Downlink Control Channel (PDCCH) and Physical Broadcast Channel (PBCH), cell-specific signals, Primary Synchronization Signal (PSS), Secondary Synchronization Signal (SSS), Cell-specific Reference Signal (CRS) or initial access, mobility, low-latency transmission. In such cases, it might be beneficial to form a broad beam shape instead.

Dual-polarized beamforming provides a way to create beams with variable half-power beamwidth (HPBW). When an antenna array of a network node operates on a pair of orthogonal polarizations (H,V), and, assuming that the receiver has a pair of antennas, one for each polarization, a radiation pattern in the power domain can be formed by

$$G ( ϕ , θ ) = {\vert A ( ϕ , θ ) \vert}^{2} {G}_{0} ( ϕ , θ ) ,$$

where φ is azimuth angle, θ is elevation angle or zenith angle, G₀(φ, θ) is the radiation pattern of a single array element, and the array factor A is given by

$${\vert A ( ϕ , θ ) \vert}^{2} = {\vert tr \{ {W}_{H}^{T} A ( ϕ , θ ) \} \vert}^{2} + {\vert tr \{ {W}_{V}^{T} A ( ϕ , θ ) \} \vert}^{2} ,$$

where H and and V represent mutually orthogonal first and second polarization directions, such as Horizontal (H) and Vertical (V), and where W_{H} and W_{V} are the beamforming matrices for the first and second polarization direction, respectively. Further, the steering matrix is given by

$$A ( ϕ , θ ) = {a}_{y}^{T} ( ϕ , θ ) ⊗ {a}_{z} ( ϕ , θ ) ,$$

where a_{y}(φ, θ) and a_{z}(φ, θ) are steering vectors in the horizontal and vertical dimensions, respectively, given by

$${a}_{y} ( ϕ , θ ) = {[ 1 , {e}^{j {ψ}_{y}} , … , {e}^{j ( M - 1 ) {ψ}_{y}} ]}^{T} ∈ {ℂ}^{M} ,$$

$${a}_{z} ( ϕ , θ ) = {[ 1 , {e}^{j {ψ}_{z}} , … , {e}^{j ( N - 1 ) {ψ}_{z}} ]}^{T} ∈ {ℂ}^{N} ,$$

where relative phase shifts are defined as

$${ψ}_{y} ( ϕ , θ ) = 2 π {d}_{y} sin θ sin ϕ ,$$

$${ψ}_{z} ( ϕ , θ ) = 2 π {d}_{z} cos θ ,$$

with d_{y} and d_{z} being antenna spacing in the horizontal and vertical dimensions, respectively.

Unfortunately, conventional beamforming is typically unable to provide broad beam shapes, but results in narrower beams the more antennas are utilized at the network node, which was discussed above. A broad beam can be defined as a radiation pattern whose array factor is flat over observation angles associated with a designated coverage area, i.e., |A(φ, θ|²=const. The radiation pattern of the antenna array thus becomes a scaled version of the radiation pattern of a single array element.

To achieve a broad beam for communication between a network node and a wireless device, it was proposed in “Efficient cell-specific beamforming for large antenna arrays,” by Girnyk & Petersson, published in IEEE Transactions on Communications 69.12, year 2021, pages 8429-8442 [Ref. 4], to choose the beamforming weights from a pair of Golay complementary arrays. Golay complementary arrays are described in “Golay complementary array pairs.” By Jedwab & Parker, published in Designs, Codes and Cryptography 44.1, year 2007, pages 209-216 [Ref. 5]. The main property of these array pairs is the complementarity of their sum aperiodic autocorrelation function (AACF). That is, sum AACF of the weight matrices is equal to zero everywhere, i.e., in every position/entry pair of the arrays, except for the 0^{th} lag, i.e.,

$${R}_{{W}_{H}} ( {τ}_{n} , {τ}_{m} ) + {R}_{{W}_{V}} ( {τ}_{n} , {τ}_{m} ) = 2 MN δ ( {τ}_{n} , {τ}_{m} ) ,$$

where R_{W}(τₙ, τₘ) is the AACF of an array W of size N×M, i.e., size of the IRS array in 2 dimensions, and δ(τₙ, τₘ) is the Kronecker delta. τₙ, τₘ are lags in the corresponding dimensions.

The complementarity property of the Golay pairs is equivalent to the property of constant sum power spectral density of the two arrays. Therefore, picking such arrays as the per-polarization beamforming weight matrices for a network node, results in a constant array factor for the beamforming, which is the desired property for achieving broad-beam transmission from the network node.

One basic idea behind embodiments of this invention is to leverage the fact that an IRS can be designed by means of dual-polarized elements, similarly to modern network node antenna arrays. In other words, any radiated wave that a conventional dual-polarized phased antenna array of a network node can generate can also be radiated from a dual-polarized IRS with the corresponding geometry. However, for an IRS, each dual-polarized element must also be configured to jointly compensate for the phase-shift of the incident signal, i.e., the signal as received by the IRS from the base station, and then assign the desired phase shift from the incident signal to mimic the process of beamforming in a phased antenna array of a corresponding network node. This may be accomplished as follows: Assuming that \hat{φ}_{m,n} is the phase shift of the element (m,n) of the IRS determined as the ε-complementary array and ϑ_{m,n} is the phase of the incident signal received by the element (m,n), the actual IRS phase shifts should be computed as φ_{m,n}=\hat{φ}_{m,n}−ϑ_{m,n}. In other words, the phase shift of the incident signal is here first cancelled and then the phase shift obtained from the ε-complementary algorithm is applied in order to get a broad beam. This subtraction of the incident angle constitutes a difference to the process of beamforming by an antenna array of a network node. More precisely, for an IRS one can design a pair of matrices W_{H} and W_{V} of phase-shift coefficients so that the reflection beampattern from the IRS in the second phase of the transmission does not get narrower but matches that of a dual-polarized phased antenna array with the aforementioned broad beamforming.

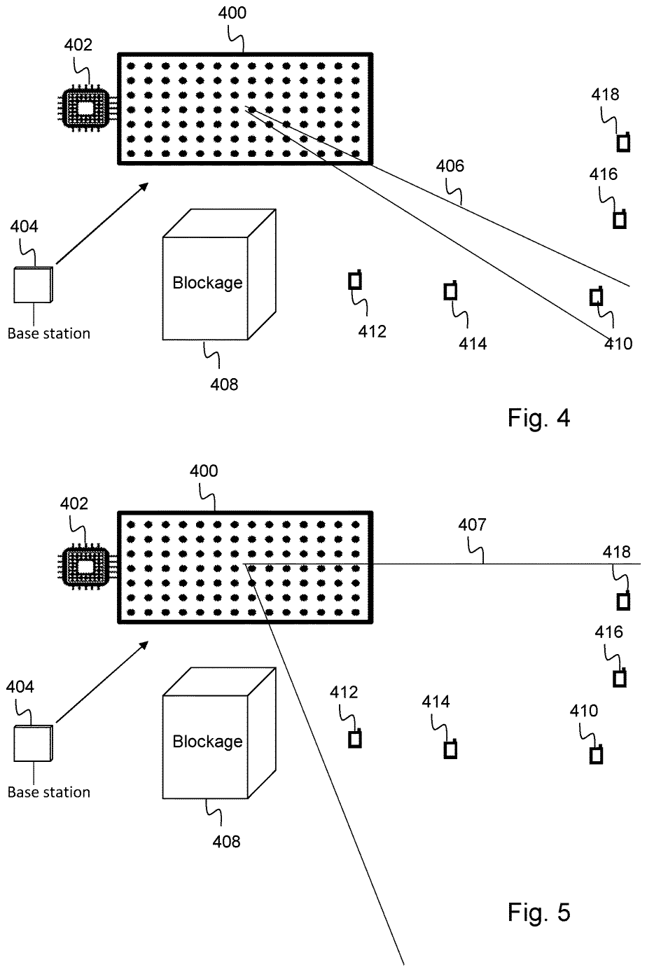

FIGS. 4 and 5 show a scenario for using an IRS 400 to reflect signals received from a network node, here called base station 404, towards one or more wireless device, here called UEs 410-418. This IRS design can be useful in cases where a direct link between the base station 404 and one or more UEs is blocked by an object that cannot be penetrated by radio signals, here called “blockage” 408. A controller 402, e.g., microcontroller, controls the IRS 400 according to the configuration received from the network node. The controller 402 has communication capabilities for receiving the configuration from the network node. For conventional use of the IRS 400, the reflected beam 406 is narrow, which is shown in FIG. 4, and hence the transmission is UE-specific, in FIG. 4 the beam 406 is directed to UE 410. This does not suit well for e.g., broadcasting of downlink control information or for supporting uplink random access transmissions. On the contrary, by making the IRS 400 capable of creating a broad reflected beam 407, as shown in FIG. 5, the transmission may benefit all UEs 410-418 shown in FIG. 5 at once.

To achieve the desired effect, a pair of complementary arrays of a size corresponding to the IRS 400 configuration is constructed, which means that each array of the pair has the same number of entries as there are dual-polarized reflecting elements in the IRS. Further, each array in the pair of complementary arrays has the same configuration as the IRS array. That is, assume the IRS array is N×M, then the pair of complementary arrays will be 2 matrices of size N×M, one matrix for each polarization.

According to an embodiment, the above can be done by either picking an array pair from a list of existing Golay pairs, or by using one of the constructions below to obtain complementary arrays of a larger size from Golay sequences or Golay arrays of a smaller size. Given two pairs of Golay sequences, (u,v) of size N and (x,y) of size K, one can obtain a pair of Golay arrays of size 2K×N as

$${W}_{H} = [ \begin{matrix}{xu}^{T} \\ - {E}_{N} {y}^{*} {v}^{T}\end{matrix} ] ,$$

$${W}_{V} = [ \begin{matrix}{yu}^{T} \\ {E}_{N} {x}^{*} {v}^{T}\end{matrix} ] ,$$

where E_{N} is the exchange matrix of size N×N.

The obtained Golay arrays can be further expanded using the following construction: Given two pairs of Golay arrays, (U,V) of size N×M and (X,Y) of size K×L, one can obtain a pair of Golay arrays of size 2NK×ML as

$${W}_{H} = [ \begin{matrix}X ⊗ U \\ - Y ⊗ ( {E}_{N} {VE}_{M} )\end{matrix} ] ,$$

$${W}_{V} = [ \begin{matrix}X ⊗ V \\ Y ⊗ ( {E}_{N} {UE}_{M} )\end{matrix} ] ,$$

where E_{M} is the exchange matrix of size M×M.

Unfortunately, the above solutions are limited by the size of the known complementary sequences. For instance, binary Golay sequences are known to exist for lengths of N=2^{a}10^{b}26^{c}, where a, b, c∈ [symbol] ₀. Quaternary Golay sequences exist for N=2^{a+f}3^{b}5^{c}11^{d}13^{e}, where f≤c+e and b+c+d+e≤a+2f+1, where a, b, c, d, e, f∈ [symbol] ₀. Thus, there are no quaternary Golay sequences of lengths N=7, 9, 14, 15, 17, 19, 21, . . . . Apart from this, very little is known about the lengths for which polyphase Golay sequences exist. In other words, it may be difficult or even impossible to find complementary sequences.

As a means to overcome this, and in accordance with an embodiment, it is proposed to relax the requirement on the complementarity, i.e., to achieve a spatially flat array factor, and allow for some limited fluctuation in the sidelobes of the sum-AACF. Therefore, a concept of ϵ-complementary sequences was introduced.

Given a certain tolerance ϵ, a pair of ϵ-complementary sequences is defined as a pair of unimodular sequences (u,v) for which

$$\vert {R}_{u} ( τ ) + {R}_{v} ( τ ) \vert \leq ϵ , ∀ τ \neq 0.$$

In this way, it is possible to use stochastic optimization to find sequences (u,v) that have very small AACF sidelobes, and hence practically tolerable flatness of the array factor of the radiation pattern. According to an embodiment, e for the sequences may be set to 0.02*N, where N=length(u,v). This can be done by means of known non-convex optimization algorithm, such as, Great Deluge, Simulated Annealing, Godlike, CANARY, etc. The Great Deluge optimization algorithm is described in Dueck, Gunter. “New optimization heuristics: The great deluge algorithm and the record-to-record travel.” Journal of Computational physics 104.1 (1993): 86-92. The Simulated Annealing optimization algorithm is described in Kirkpatrick, Scott, C. Daniel Gelatt Jr, and Mario P. Vecchi. “Optimization by simulated annealing.” Science 220.4598 (1983): 671-680. The Godlike optimization algorithm is described in Oldenhuis, Rody P S. “Trajectory optimization for a mission to the solar bow shock and minor planets.” (2010). The CANARY optimization algorithm is described in Soltanalian, Mojtaba, Mohammad Mahdi Naghsh, and Petre Stoica. “A fast algorithm for designing complementary sets of sequences.” Signal Processing 93.7 (2013): 2096-2102

It is noteworthy that ϵ-complementary sequences and arrays can be expanded in the same way as Golay sequences and arrays, using the aforementioned construction procedures, while preserving the sum-AACF sidelobe level. This allows us to significantly extend the IRS configurations for which it is possible to form broad beams. That is, the gaps for the quaternary Golay sequences, N=7, 9, 14, 15, 17, 19, 21, . . . , could be well covered by the corresponding polyphase ϵ-complementary sequences.

As applicable to both embodiments of Golay and ϵ-complementary arrays, the configuration matrices can be stored locally at the IRS a priori with the required accuracy. This is in contrast to conventional UE-specific IRS configurations that are computed at the receiver using short-term channel state information and then sent to the IRS using a limited numerical accuracy manifested by the feedback link.

One issue with IRS is that there may be small amplitude variations between the different configurations, so one cannot control the phase and amplitude completely independently. According to an embodiment, this dependency between an IRS configuration's phases and amplitudes can be modeled in a similar way as in “Intelligent Reflecting Surface: Practical Phase Shift Model and Beamforming Optimization,” by Abeywickrama et al., published in IEEE Transactions on Communications, 68.9, year 2020, pages 5849-5863 [Ref. 6]. In [Ref. 6], an excitation coefficient, w_{n,m}, is given by

$${w}_{n , m} = {β}_{n , m} ( {φ}_{n , m} ) {e}^{φ n , m} ,$$

where β is the amplitude, φ is the phase, and n, m are indexes of dual-polarized elements in the IRS. Further, the amplitude β is a function of its phase φ, given by

$${β}_{n , m} ( {φ}_{n , m} ) = {( 1 - {β}_{min} ) [ \frac{sin ( {φ}_{n , m} - ω ) + 1}{2} ]}^{α} + {β}_{min} ,$$

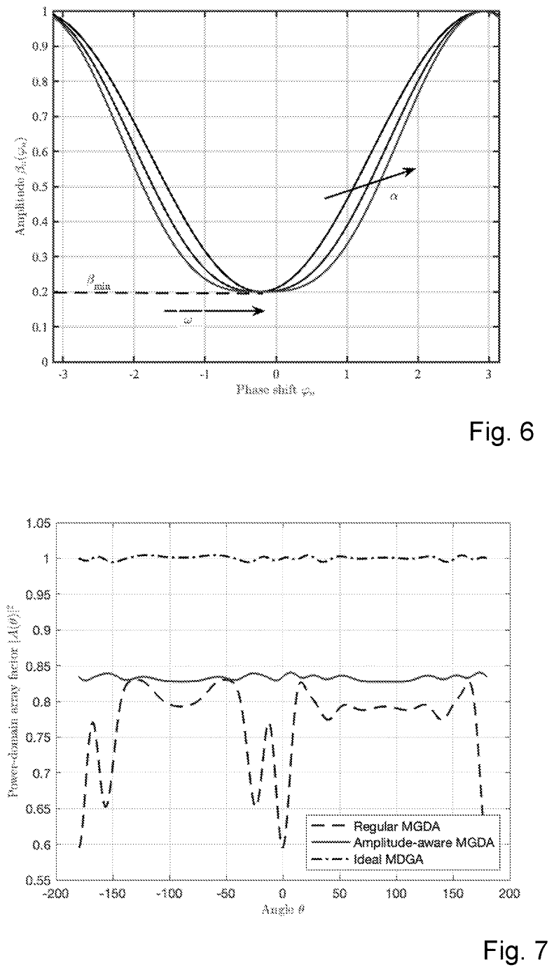

with (βₘᵢₙ, α, ω) being constants related to a specific implementation of circuitry. Here βₘᵢₙ controls the minimum amplitude, ω controls the phase position of the minimum amplitude, with respect to −π/2, and α controls the steepness of the amplitude function curve. FIG. 6 shows a possible amplitude-phase relation and the corresponding circuit-specific parameters.

Based on the above model, the amplitude-phase relation can be implemented into the excitation array optimization. For instance, the objective function of the stochastic optimization Modified Great Deluge Algorithm (MGDA) algorithm proposed in [Ref. 4] can be redesigned. For instance, when computing the utility function, one can incorporate the aforementioned amplitude scaling as

$${w}_{n , m} = {w}_{n , m} \cdot {β}_{n , m} ( {φ}_{n , m} ) ,$$

where φ_{n,m} is a current phase of a coefficient. By updating all coefficients in both W_{H} and W_{V} according to the above formula, one can then recompute the 2D AACFs R_{W}_{_{H}}(τₙ, τₘ) and R_{W}_{_{V}}(τₙ, τₘ) with new coefficients for these arrays, and then compute the utility function as

$$U ( φ ) = - {max}_{τ \neq 0} \{ {R}_{{W}_{H}} ( {τ}_{n} , {τ}_{m} ) + {R}_{{W}_{V}} ( {τ}_{n} , {τ}_{m} ) \} .$$

The stochastic-optimization MGDA algorithm is presented below. The corresponding stochastic process describes the movement of a current state point over a landscape formed by the utility function U(φ). In contrast to convex-optimization gradient ascent approach, which may move only uphill, MGDA is allowed to move the current state both uphill and downhill, as long as it is above a certain water level. This prevents the MGDA from being quickly stuck at a local maximum. During the optimization, the water level keeps increasing, forcing the algorithm to escape into areas of higher utility, and eventually end up near a (hopefully global) maximum.

The implementation of this principle is done by increasing each phase φᵢ by a corresponding increment value Δφᵢ. Then, the resulting value of the utility function U(φ) is examined. If the utility value is above the water level, the new state is accepted and the next phase is altered; otherwise, the phase step is taken in the opposite direction and the corresponding utility value is compared to the water level. If no increase is accepted in any of the directions, the step size is decreased by a factor γ<1 and the procedure is repeated until an eligible step is accepted. In addition to the above, large-scale exploration is added to the algorithm. Namely, we track whether the number of unsuccessful alternations is greater than a certain number dₘₐₓ. If so, the system takes a large step to a new random configuration, and the entire process restarts. The algorithm is terminated when the utility function reaches the neighborhood of the known optimum, U(φ)=0, as determined by the adopted tolerance level ε.

For running the algorithm, we first vectorize and stack together the phases of the beamforming matrices W_{H} and W_{V} into a single vector φ of size 2MN. This phase vector is then optimized by means of MGDA and mapped back into optimized beamforming matrices W_{H} and W_{V}.

By doing so, it is possible to obtain an optimized pair of beamforming weight matrices W_{H} and W_{V} that take into account the amplitude variations incurred by the excitations' phases and incorporate those into the utility function U(φ), hence, we refer to this algorithm as “amplitude-aware” MGDA. That is, the new optimized phases are able to produce a flat array factor, in other words, a beam as broad as the radiation pattern of a single reflector, with non-unimodular beamforming weights, as described in FIG. 7.

FIG. 7 demonstrates the effects of flat array factor design when there is an amplitude variation and amplitude-phase dependency. For instance, when designing broad-beam weights for a 7-antenna uniform linear array (ULA) by means of the MGDA of [Ref. 4], and then applying the aforementioned amplitude distortion, we see that the produced array factor is no longer flat (see dashed line of FIG. 7). What we would like to see is a curve similar to that of the ideal case of spatially flat array factor with unimodular beamforming weights (see dash-dotted line of FIG. 7). However, the proposed amplitude-aware MGDA approach can produce a spatially flat array factor, even with amplitude-distorted weights, see the solid line of FIG. 7. Of course, there is a loss in power with relation to the ideal case due to the non-unimodularity of the weights. However, the main benefit of flat array factor, i.e., broad beam, remains.

According to an embodiment, the base station is arranged to trigger switching of configuration at the IRS between UE-specific beamforming mode and broad beamforming mode over time. The base station can either actively inform the IRS when to switch between these configurations or keep the IRS synchronized with the transmission protocols, so the IRS can automatically switch to broad beamforming during downlink broadcasting and uplink random access. There are different ways to trigger a switch between the two configurations. It can be done periodically (automatically, but needs synchronization) to match with the Time Division Duplex (TDD) protocol, where control signals and random access are transmitted in particular time slots, which calls for broad beams. It can also be done on demand by having a decision process where the base station makes computations to determine when it is desired to switch from/to broad beams. For example, if a UE is served that only requires a short data package, it may be beneficial to spend resources on configuring the IRS for that UE, thus the network node can trigger the IRS to switch to broad beam configuration because that is better than having a “random” configuration.

In another embodiment, based on the information on coverage area, the IRS can be configured to achieve a beam that fits with the coverage area that is desired for the moment. For example, the IRS is configured to achieve a nearly constant array factor for all possible angular directions. Alternatively, the IRS is configured to create a broad beam that matches with a smaller coverage area, e.g., a street or a room, or 2D versus 3D coverage. Still alternatively, the IRS is configured to produce an array factor that is not constant but varies according to a predetermined angular pattern to provide desired coverage. Information about the propagation environment can be gathered so that the broad beam is designed to “fill all holes” but not ignore locations where the signal strength is anyway good, or so that the IRS can have a predefined collection of broad beams, like a DFT grid but broader. The base station can then tell the IRS which one of those to use, depending on measurements that it makes about what would be preferable for the moment.

There are reflective and transmissive IRS. A reflective IRS reflects the signal as a reconfigurable mirror and the transmissive IRS lets the signal through the surface but changes the properties of the signal when it is reradiated at the other side. The embodiments described above for a reflective IRS are also applicable to a transmissive IRS. A reflective IRS normally reflects signals only in the half-space in front of it. a transmissive IRS on the other hand, “reflects” signals into the opposite half space (e.g., enabling signals to enter a room).

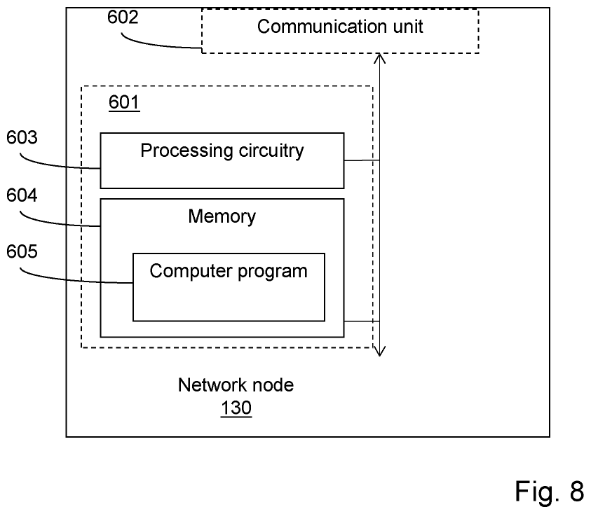

FIG. 8, in conjunction with FIG. 1, describes a network node 130 configured to operate in a wireless communication network 100, and operative for configuring an intelligent reflective surface, IRS, 150 of the wireless communication network 100. The IRS 150 comprises a plurality of dual-polarized reflective elements. Each dual-polarized reflective element is independently controllable regarding phase shift for a first polarization and phase shift for a second polarization orthogonal to the first polarization. The network node 130 comprises a processing circuitry 603 and a memory 604. Said memory contains instructions executable by said processing circuitry, whereby the network node 130 is operative for determining a configuration for the IRS, the configuration comprising individual phase shifts per first and second polarization of the plurality of dual-polarized reflective elements. The individual phase shifts per first and second polarization of the plurality of dual-polarized elements are determined so that the IRS can redirect a signal, received from the network node as a dual-polarized beam, over an angular sector made up from a plurality of angular subsectors as a beam having substantially same power-domain array factor over the angular subsectors. Further, in this determining, the individual phase shifts per first and second polarization of the dual-polarized reflective elements are compensated for a phase shift of the signal received from the network node. The network node is further operative for triggering application of the determined configuration at the IRS 150, and for transmitting, after the triggering of application of the determined configuration, a signal towards one or more wireless devices 140, 142 residing in the angular sector via reflection at the IRS 150.

According to an embodiment, the network node 130 is operative for the determining of a configuration for the IRS 150 by selecting the individual phase shifts per first and second polarization of the plurality of dual-polarized reflective elements so that over the angular sector, power in the first polarization and power in the second polarization of the redirected dual-polarized beam are complementing each other at each of the plurality of angular subsectors, resulting in that substantially the same power-domain array factor of the redirected dual-polarized beam is achieved over the plurality of angular subsectors.

According to another embodiment, the network node 130 is operative for selecting the individual phase shifts per first and second polarization of the plurality of dual-polarized reflective elements as a pair of Golay arrays for which a sum of the aperiodic autocorrelation functions of the two Golay arrays of the pair is zero for each non-zero lag. Further, each Golay array in the pair has the same number of entries as there are dual-polarized reflective elements in the IRS. Further, one Golay array of the pair is applicable for the first polarization of the dual-polarized elements and the other Golay array of the pair is applicable for the second polarization of the dual-polarized elements.

According to another embodiment, the network node 130 is operative for selecting the individual phase shifts per first and second polarization of the plurality of dual-polarized reflective elements as a pair of ε-complementary arrays for which a sum of the aperiodic autocorrelation functions of the two arrays of the pair is lower than ε for each non-zero lag, where ε≠0. Further, each ε-complementary array in the pair has the same number of entries as there are dual-polarized reflective elements in the IRS. Further, one ε-complementary array of the pair is applicable for the first polarization of the dual-polarized elements and the other ε-complementary array of the pair is applicable for the second polarization of the dual-polarized elements.

According to yet another embodiment, the network node 130 is operative for the determining of the individual phase shifts per first and second polarization of the plurality of dual-polarized elements taking into consideration, except for phase, also amplitude variations by modelling the amplitude as a function of the phase.

According to yet another embodiment, the network node 130 is further operative for, after the transmitting of a signal towards one or more wireless devices 140, 142, 144 residing in the angular sector, triggering switching of configuration at the IRS from the determined configuration to a wireless-device specific configuration. Alternatively, the network node 130 is operative for the triggering of application of the determined configuration at the IRS by triggering switching of configuration at the IRS from a wireless-device specific configuration to the determined configuration.

According to other embodiments, the network node 130 may further comprise a communication unit 602, which may be considered to comprise conventional means for wireless communication with the wireless devices 140, 142 via the IRS 150, such as a transceiver for wireless transmission and reception of signals in the communication network. The communication unit 602 may also comprise conventional means for communication with other network nodes of the wireless communication network 100. The instructions executable by said processing circuitry 603 may be arranged as a computer program 605 stored e.g., in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the network node 130 to perform the steps described in any of the described embodiments of the network node 130 and its method. The computer program 605 may be carried by a computer program product connectable to the processing circuitry 603. The computer program product may be the memory 604, or at least arranged in the memory. The memory 604 may be realized as for example a Random-access memory (RAM), Read-Only Memory (ROM) or an Electrical Erasable Programmable ROM (EEPROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g., a CD, DVD or flash memory, from which the program could be downloaded into the memory 604. Alternatively, the computer program may be stored on a server or any other entity to which the network node 130 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1-14. (canceled)

15. A method performed by a network node of a wireless communication network, for configuring an intelligent reflective surface (IRS) of the wireless communication network, the IRS comprising a plurality of dual-polarized reflective elements, each dual-polarized reflective element being independently controllable regarding phase shift for a first polarization and phase shift for a second polarization orthogonal to the first polarization, the method comprising:
determining a configuration for the IRS, the configuration comprising individual phase shifts per first and second polarization of the plurality of dual-polarized reflective elements, determined so that the IRS can redirect a signal, received from the network node as a dual-polarized beam, over an angular sector made up from a plurality of angular subsectors as a beam having substantially same power-domain array factor over the angular subsectors, and whereby in the determining, the individual phase shifts per first and second polarization of the dual-polarized reflective elements are compensated for a phase shift of the signal received from the network node;
triggering application of the determined configuration at the IRS, and
transmitting, after the triggering of application of the determined configuration, a signal towards one or more wireless devices residing in the angular sector via reflection at the IRS.

16. The method of claim 15, wherein in the determining of a configuration for the IRS, the individual phase shifts per first and second polarization of the plurality of dual-polarized reflective elements are selected per first and second polarization so that over the angular sector, power in the first polarization and power in the second polarization of the redirected dual-polarized beam are complementing each other at each of the plurality of angular subsectors, resulting in that substantially the same power-domain array factor of the redirected dual-polarized beam is achieved over the plurality of angular subsectors.

17. The method of claim 15, wherein the individual phase shifts per first and second polarization of the plurality of dual-polarized reflective elements are selected as a pair of Golay arrays for which a sum of the aperiodic autocorrelation functions of the two Golay arrays of the pair is zero for each non-zero lag, each Golay array in the pair having the same number of entries as there are dual-polarized reflective elements in the IRS, one Golay array of the pair applicable for the first polarization of the dual-polarized elements and the other Golay array of the pair applicable for the second polarization of the dual-polarized elements.

18. The method of claim 15, wherein the individual phase shifts per first and second polarization of the plurality of dual-polarized reflective elements are selected as a pair of ε-complementary arrays for which a sum of the aperiodic autocorrelation functions of the two arrays of the pair is lower than ε for each non-zero lag, where ε≠0, each ε-complementary array in the pair having the same number of entries as there are dual-polarized reflective elements in the IRS, one ε-complementary array of the pair applicable for the first polarization of the dual-polarized elements and the other ε-complementary array of the pair applicable for the second polarization of the dual-polarized elements.

19. The method of claim 15, wherein the individual phase shifts per first and second polarization of the plurality of dual-polarized elements are determined taking into consideration, except for phase, also amplitude variations by modelling the amplitude as a function of the phase.

20. The method of claim 15, further comprising:
after the transmitting of a signal towards one or more wireless devices residing in the angular sector, triggering switching of configuration at the IRS from the determined configuration to a wireless-device specific configuration, or
wherein the triggering of application of the determined configuration at the IRS comprises triggering switching of configuration at the IRS from a wireless-device specific configuration to the determined configuration.

21. A network node configured to operate in a wireless communication network, and operative for configuring an intelligent reflective surface (IRS) of the wireless communication network, the IRS comprising a plurality of dual-polarized reflective elements, each dual-polarized reflective element being independently controllable regarding phase shift for a first polarization and phase shift for a second polarization orthogonal to the first polarization, the network node comprising a processing circuitry and a memory, said memory containing instructions executable by said processing circuitry, whereby the network node is configured to:
determine a configuration for the IRS, the configuration comprising individual phase shifts per first and second polarization of the plurality of dual-polarized reflective elements, determined so that the IRS can redirect a signal, received from the network node as a dual-polarized beam, over an angular sector made up from a plurality of angular subsectors as a beam having substantially same power-domain array factor over the angular subsectors, and whereby in the determining, the individual phase shifts per first and second polarization of the dual-polarized reflective elements are compensated for a phase shift of the signal received from the network node;
trigger application of the determined configuration at the IRS, and
transmit, after the triggering of application of the determined configuration, a signal towards one or more wireless devices residing in the angular sector via reflection at the IRS.

22. The network node of claim 21, wherein the network node is configured to determine a configuration for the IRS by selecting the individual phase shifts per first and second polarization of the plurality of dual-polarized reflective elements so that over the angular sector, power in the first polarization and power in the second polarization of the redirected dual-polarized beam are complementing each other at each of the plurality of angular subsectors, resulting in that substantially the same power-domain array factor of the redirected dual-polarized beam is achieved over the plurality of angular subsectors.

23. The network node of claim 20, wherein the network node is configured to select the individual phase shifts per first and second polarization of the plurality of dual-polarized reflective elements as a pair of Golay arrays for which a sum of the aperiodic autocorrelation functions of the two Golay arrays of the pair is zero for each non-zero lag, each Golay array in the pair having the same number of entries as there are dual-polarized reflective elements in the IRS, one Golay array of the pair applicable for the first polarization of the dual-polarized elements and the other Golay array of the pair applicable for the second polarization of the dual-polarized elements.

24. The network node of claim 20, wherein the network node is configured to select the individual phase shifts per first and second polarization of the plurality of dual-polarized reflective elements as a pair of ε-complementary arrays for which a sum of the aperiodic autocorrelation functions of the two arrays of the pair is lower than ε for each non-zero lag, where ε≠0, each ε-complementary array in the pair having the same number of entries as there are dual-polarized reflective elements in the IRS, one ε-complementary array of the pair applicable for the first polarization of the dual-polarized elements and the other ε-complementary array of the pair applicable for the second polarization of the dual-polarized elements.

25. The network node of claim 20, wherein the network node is configured to determine the individual phase shifts per first and second polarization of the plurality of dual-polarized elements taking into consideration, except for phase, also amplitude variations by modelling the amplitude as a function of the phase.

26. The network node of claim 20, further being configured to, after the transmitting of a signal towards one or more wireless devices residing in the angular sector, trigger switching of configuration at the IRS from the determined configuration to a wireless-device specific configuration, or configured to trigger application of the determined configuration at the IRS by triggering switching of configuration at the IRS from a wireless-device specific configuration to the determined configuration.
